(19) United States
(12) Patent Application Publication
(10) Pub. No.: US 2025/0383794 A1
(43) Pub. Date: Dec. 18, 2025

(54) SHARED COMMAND BUS ARCHITECTURE FOR MEMORY SYSTEMS

(71) Applicant: Micron Technology, Inc., Boise, ID (US)

(72) Inventors: Dustin L. Holloway, Boise, ID (US); Jonathan S. Parry, Boise, ID (US); Ali Feiz Zarrin Ghalam, Sunnyvale, CA (US)

(21) Appl. No.: 19/221,287

(22) Filed: May 28, 2025

Related U.S. Application Data
(60) Provisional application No. 63/659,242, filed on Jun. 12, 2024.

(51) Int. Cl. G06F 3/06

(52) U.S. Cl. CPC G06F 3/0626; G06F 3/0635; G06F 3/0673

(57) ABSTRACT

Methods, systems, and devices for shared command bus architecture for memory systems are described. A memory system communicating according to a separate command address (SCA) protocol may implement a shared command bus between a memory system controller and multiple memory devices. The memory system may include processing circuitry coupled with a first memory device and a second memory device. The processing circuitry may be configured to communicate first data with a first memory device via a first data bus and may be configured to communicate second data with a second memory device via a second data bus. The memory system may include a command bus in which each pin of the command bus is common to the first memory device and the second memory device, such that each pin is configured to communicate signaling associated with commands to the first memory device and the second memory device.

### CROSS REFERENCE

The present application for patent claims priority to U.S. Patent Application No. 63/659,242 by Holloway et al., entitled “SHARED COMMAND BUS ARCHITECTURE FOR MEMORY SYSTEMS,” filed Jun. 12, 2024, which is assigned to the assignee hereof, and which is expressly incorporated by reference in its entirety herein.

### TECHNICAL FIELD

The following relates to one or more systems for memory, including shared command bus architecture for memory systems.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports shared command bus architecture for memory systems in accordance with examples as disclosed herein.

FIGS. 2A and 2B show examples of systems that support shared command bus architecture for memory systems in accordance with examples as disclosed herein.

FIG. 3 shows an example of a process that supports shared command bus architecture for memory systems in accordance with examples as disclosed herein.

FIG. 4 shows a block diagram of a memory system that supports shared command bus architecture for memory systems in accordance with examples as disclosed herein.

FIG. 5 shows a flowchart illustrating a method or methods that support shared command bus architecture for memory systems in accordance with examples as disclosed herein.

### DETAILED DESCRIPTION

Some memory systems may implement an interface, such as an open NAND flash interface (ONFI), to support communication between one or more memory system controllers and one or more memory devices of the memory system. In some cases, the memory system controllers may communicate commands and data associated with commands to the memory devices using a protocol, such as a separate command address (SCA) protocol. Such a protocol may implement a data bus (e.g., a data channel, a set of pins configured to communicate signaling associated with data) between a memory system controller and a memory device used to communicate data, and a separate command bus (e.g., a command channel, a set of pins configured to communicate signaling associated with commands) between the memory system controller and the memory device used to communicate commands to the memory device. Some memory systems may include multiple memory devices, and may implement a separate data bus for each memory device, which may improve data throughput by allowing the system to communicate data with multiple memory devices concurrently. However, some such memory systems may additionally include a separate command bus for each memory device. Because each command bus may include a set of pins, increasing the quantity of command busses in a memory system may increase the overall footprint of the memory system, increase design complexity to account for the increased quantity of pins, or both.

As described herein, a memory system communicating according to an SCA protocol may implement a shared command bus between a memory system controller and multiple memory devices. For example, the memory system may include processing circuitry, such as one or more memory controllers coupled with a first memory device and a second memory device. The processing circuitry may be configured to communicate first data with a first memory device via a first data bus, and may be configured to communicate second data with a second memory device via a second data bus. The memory system may include a command bus in which each pin of the command bus is common to the first memory device and the second memory device, such that each pin is configured to communicate signaling associated with commands to the first memory device and the second memory device. By implementing a shared command bus, a memory system may reduce the quantity of pins between the processing circuitry and the memory devices, which may in turn reduce the overall size of the memory system (e.g., the footprint of the memory system), may reduce design complexity by allowing for increased design flexibility, or both, among other benefits.

In addition to applicability in memory systems as described herein, techniques for a shared command bus architecture may be generally implemented to improve the sustainability of various electronic devices and systems. As the use of electronic devices has become even more widespread, the quantity of energy used and harmful emissions associated with production of electronic devices and device operation has increased. Further, the amount of waste (e.g., electronic waste) associated with disposal of electronic devices may also pose environmental concerns. Implementing the techniques described herein may improve the impact related to electronic devices by reducing the overall size of memory systems and thus reducing materials used in production of electronic devices, eliminating production processes, which may result in lowered production emissions and reduce electronic waste, among other benefits.

Features of the disclosure are illustrated and described in the context of systems, devices, and circuits. Features of the disclosure are further illustrated and described in the context of systems, processes, and flowcharts.

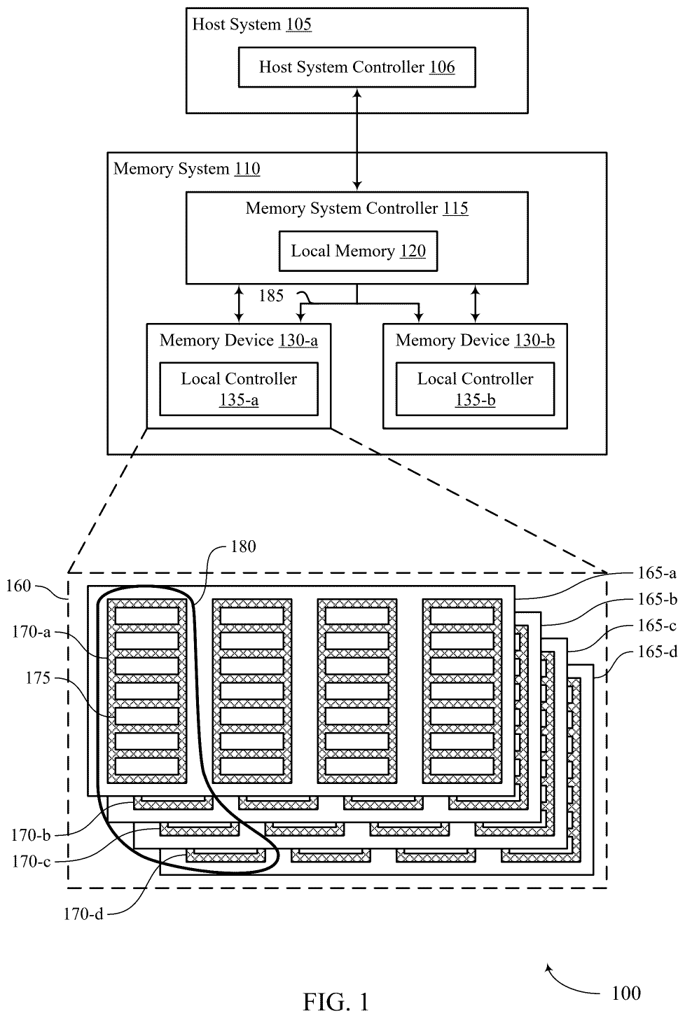

FIG. 1 shows an example of a system 100 that supports shared command bus architecture for memory systems in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

The system 100 may include any quantity of non-transitory computer readable media that support shared command bus architecture for memory systems. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

In some cases, a memory system 110 communicating according to an SCA protocol may implement a shared command bus between a memory system controller 115 and multiple memory devices 130. For example, the memory system 110 may include processing circuitry, such as one or more memory controllers 115 coupled with a first memory device 130 and a second memory device 130. The processing circuitry may be configured to communicate first data with a first memory device 130 via a first data bus, and may be configured to communicate second data with a second memory device 130 via a second data bus. The memory system 110 may include a command bus 185 in which each pin of the command bus 185 is common to the first memory device 130 and the second memory device 130, such that each pin is configured to communicate signaling associated with commands to the first memory device 130 and the second memory device 130. By implementing a shared command bus 185, a memory system 110 may reduce the quantity of pins between the processing circuitry and the memory devices 130, which may in turn reduce the overall size of the memory system 110 (e.g., the footprint of the memory system 110), may reduce design complexity by allowing for increased design flexibility, or both, among other benefits.

The system 100 may include any quantity of non-transitory computer readable media that support shared command bus architecture for memory systems. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

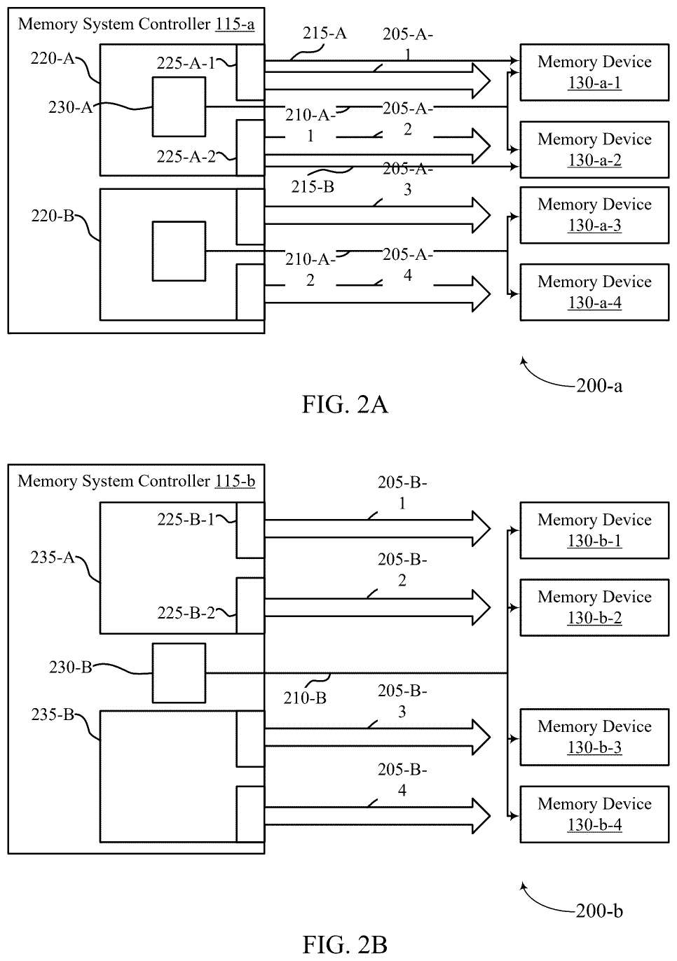

FIGS. 2A and 2B show examples of systems 200-a and 200-b, respectively, that support shared command bus architecture for memory systems in accordance with examples as disclosed herein. The systems 200-a and 200-b include aspects of the memory system 110 as described with reference to FIG. 1. For example, the systems 200-a and 200-b may include one or more memory system controllers 115-a and 115-b, respectively, which may be examples an application specific integrated circuit (ASIC) controller. The memory controllers 115 may be configured to communicate data with one or more memory devices 130 (e.g., NAND memory devices) using one or more data buses 205. For example, the memory system controller 115-a may be configured to communicate first data with a memory device 130-a-1 using a data bus 205-a-1, may be configured to communicate second data with a memory device 130-a-2 using a data bus 205-a-2, may be configured to communicate third data with a memory device 130-a-3 using a data bus 205-a-3, and may be configured to communicate fourth data with a memory device 130-a-4 using a data bus 205-a-4. Similarly, the memory system controller 115-b may be configured to communicate fifth data with a memory device 130-b-1 using a data bus 205-b-1, may be configured to communicate sixth data with a memory device 130-b-2 using a data bus 205-b-2, may be configured to communicate seventh data with a memory device 130-b-3 using a data bus 205-b-3, and may be configured to communicate eighth data with a memory device 130-b-4 using a data bus 205-b-4.

The systems 200-a and 200-b may include one or more command busses 210 that are shared between multiple memory device 130. For example, the system 200-a may include a command bus 210-a-1 that couples the memory system controller 115-a with the memory device 130-a-1 and the memory device 130-a-2, and may include a command bus 210-a-2 that couples the memory system controller 115-a with the memory device 130-a-3 and the memory device 130-a-4. In such an arrangement, the command bus 210-a-1 may be common to the memory device 130-a-1 and the memory device 130-a-2, and the command bus 210-a-2 may be common to memory device 130-a-3 and the memory device 130-a-4. Additionally, the system 200-b may include a command bus 210-b that couples the memory system controller 115-b with the memory device 130-b-1, the memory device 130-b-2, the memory device 130-b-3, and the memory device 130-b-4. In such an arrangement, the command bus 210-b may be common to the memory device 130-b-1 through the memory device 130-b-4.

A command bus 210 may include a set of dedicated pins used to communicate signaling associated with commands. For example, a command bus 210 may include one or more pins, such as a first pin and a second pin (e.g., a CA(0) pin and a CA(1) pin), configured to communicate an indication of a command from a memory system controller 115 to a memory device 130. Additionally, the command bus 210 may include a third pin (e.g., a CA_CLK pin) configured to communicate a clock signal to support the indication of the command. In some cases, the command bus 210 may communicate commands in accordance with an SCA protocol.

Each pin of a command bus 210 may be coupled with each memory device 130 to which the command bus is common. As described herein, a command bus 210 that is common to a set of memory devices 130 may be configured to communicate commands to each of the set of memory devices 130. For example, to communicate a command to the memory device 130-a-1, the memory system controller 115-a may broadcast the command across the command bus to both the memory device 130-a-1 and the memory device 130-a-2.

To support communicating commands to each memory device 130 on a command bus 210, the commands may be multiplexed (e.g., time multiplexed) on the command bus. For example, the memory system controller 115-a may broadcast a first command intended for the memory device 130-a-1 over the command bus 210-a-1 during a first time interval and may broadcast a second command intended for the memory device 130-a-2 over the command bus 210-a-1 during a second time interval subsequent to the first timer interval.

In some examples, to differentiate commands intended for a particular memory device 130, the systems 200-a and 200-b may include one or more chip enable pins used to indicate the intended recipient of a command. For example, the system 200-a may include a chip enable pin 215-a between the memory system controller 115-a and the memory device 130-a-1 and a chip enable pin 215-b between the memory system controller 115-a and the memory device 130-a-2. To transmit a first command to the memory device 130-a-1 over the command bus 210-a-1, the memory system controller 115-a may broadcast the first command to the memory device 130-a-1 and to the memory device 130-a-2. The memory system controller 115-a may activate the chip enable pin 215-a (e.g., by transmitting an activation signal over the chip enable pin 215-a, by driving the chip enable pin 215-a to an activated state, such as a high state), and in some cases may deactivate the chip enable pin 215-b (e.g., by transmitting a deactivation signal over the chip enable pin 215-b, by driving the chip enable pin 215-a to a deactivated state, such as a low state). Similarly, to transmit a second command to the memory device 130-a-2 over the command bus 210-a-1, the memory system controller 115-a may broadcast the second command to the memory device 130-a-1 and to the memory device 130-a-2. The memory system controller 115-a may activate the chip enable pin 215-b, and in some cases may deactivate the chip enable pin 215-a.

In some examples, a memory device 130 may include multiple memory dies (e.g., a set of memory dies 160 as described with reference to FIG. 1). The memory system controller 115 may communicate data with the multiple memory dies of a memory device 130 using the data bus 205 and the shared command bus 210 associated with memory device 130. In some such cases, the systems 200-a and 200-b may include multiple chip enable pins 215 between the memory system controller 115 and a single memory device 130. For example, if a memory device 130 includes a quantity of memory dies, the system 200 may include the same quantity of chip enable pins 215 between the memory system controller 115 and the memory device 130 to differentiate commands intended for a particular memory die. Alternatively, the system 200 may include fewer chip enable pins 215 (e.g., one chip enable pin 215) between the memory system controller 115 and the memory device 130 than the quantity of memory dies included in the memory device 130 (e.g., two or more memory dies within the memory device may share a chip enable pin 215). For example, in such cases, the chip enable pins 215 may be configured to allow memory device to differentiate commands intended for a particular memory die within the memory device 130 based on something other than die-specific chip enable signals (e.g., using an addressing scheme, information included in the command, or other appropriate configuration).

A data bus 205 may include a set of pins separate from the pins of a command bus 210. For example, a data bus 205 may include one or more pins configured to communicate data associated with an access command, such as by transmitting data associated with a write command from a memory system controller 115 to a memory device 130, by transmitting data associated with a read command from a memory device 130 to a memory system controller 115, or both. Additionally, a data bus may include one or more pins configured to communicate a clock signal to support transmitting data. In some cases, the memory system controller 115 may operate a first clock signal associated with a command bus 210 independently from a second clock signal associated with a data bus 205. For example, the memory system controller 115 may operate the first clock signal according to a first clock rate, and may operate the second clock signal according to a second clock rate different than the first clock rate.

In some examples, a clock rate of a command bus 210 may be modified relative to a clock rate of a data bus 205. For example, a memory system controller 115 may multiplex (e.g., time multiplex) commands on a command bus 210 to support communicating commands to multiple memory devices 130 using the shared command bus 210. To maintain saturation of the data busses 205, and thus reduce latency, the command bus 210 may be configured to communicate at a faster rate than the data busses 205. For example, a memory system controller 115 may be configured to operate a data bus 205 at a first clock rate (e.g., according to a first clock), and may be configured to operate a command bus 210 at a second clock rate (e.g., according to a second clock) faster than the first clock rate. Accordingly, the memory system controller 115 may issue commands to the memory devices 130 at an increases rate, which may allow for saturation of the data busses 205 and thus decrease latency.

In some examples, components of the systems 200-a and 200-b may be manufactured using one or more modular components, which may be examples of “units” of circuitry that may be repeated throughout the design of the systems 200-a and 200-b. For example, the memory system controller 115-a may include one or more modular interfaces 220, such as an interface 220-a and an interface 220-b. An interface 220 may include circuitry used to transmit and receive signaling over a command bus 210, a data bus 205, one or more chip enable pins, or a combination thereof. For example, the interface 220-a may include circuitry 225-a-1 that couples the memory system controller 115-a with the data bus 205-a-1 and may include circuitry 225-a-2 that couples the memory system controller 115-a with the data bus 205-a-2. Additionally, the interface 220-a may include a command router 230-a, which may be an example of circuitry that couples the memory system controller 115-a with the command bus 210-a-1.

Additionally, or alternatively, the memory system controller 115-b may include one or more modular interfaces 235, such as an interface 235-a and an interface 235-b. An interface 235 may include circuitry used to transmit and receive signaling over a command bus 210, a data bus 205, one or more chip enable pins, or a combination thereof. For example, the interface 235-a may include circuitry 225-b-1 that couples the memory system controller 115-a with the data bus 205-a-1 and may include circuitry 225-b-2 that couples the memory system controller 115-a with the data bus 205-a-2. Additionally, the memory system controller 115-b include a command router 230-b separate from (e.g., external to) the interfaces 235-a and 235-b, which may be an example of circuitry that couples the memory system controller 115-b with the command bus 210-b.

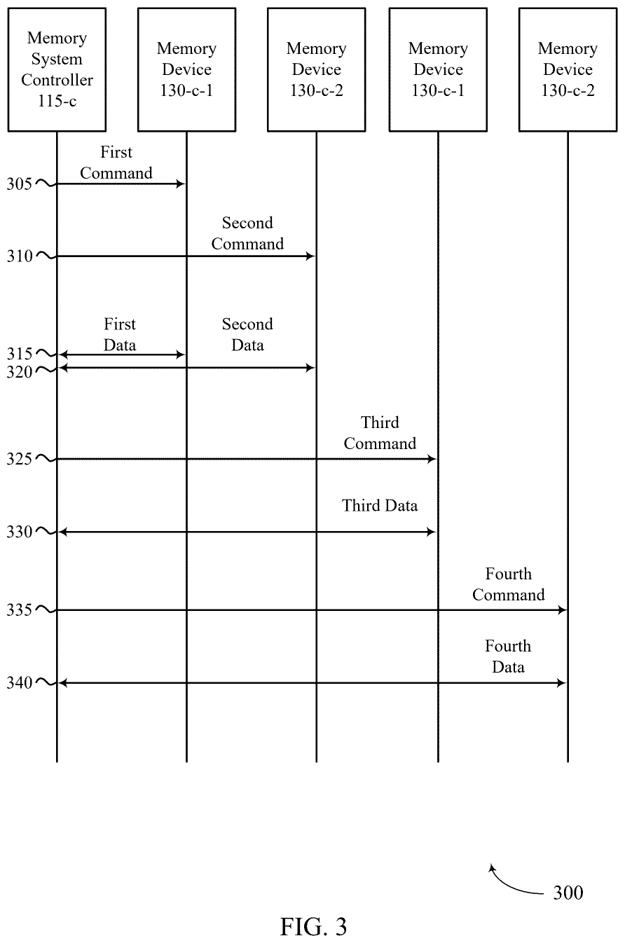

FIG. 3 shows an example of a process 300 that supports shared command bus architecture for memory systems in accordance with examples as disclosed herein. In some examples, a memory system, which may be an example of the memory system 110, a system 200-a, a system 200-b, or a combination thereof, as described with reference to FIGS. 1 through 2B, may implement aspects of the process 300 using a memory system controller 115-c. In the following description of process 300, the operations may be performed in a different order than the order shown. For example, specific operations may also be left out of process 300, or other operations may be added to process 300.

Aspects of the process 300 may be implemented by processing circuitry, such as one or more controllers, among other components. Additionally, or alternatively, aspects of the process 300 may be implemented as instructions stored in one or more memories (e.g., firmware stored in one or more memories, such as a memory device 130 or local memory 120 (or both), coupled with the memory system). For example, the instructions, when executed by one or more controllers (e.g., the memory system controller 115-c), may cause the one or more controllers (or a device or a system) to perform the operations of the process 300.

The process 300 may illustrate a method to communicate according to an SCA protocol using a shared command bus between a memory system controller 115-c and multiple memory devices 130. For example, the memory system may communicate first data with a first memory device 130-c-1 via a first data bus, and may communicate second data with a second memory device 130-c-2 via a second data bus. The memory system may include a command bus in which each pin of the command bus is common to the first memory device 130-c-1 and the second memory device 130-c-2, such that each pin is configured to communicate signaling associated with commands to the first memory device 130-c-1 and the second memory device 130-c-2. By implementing a shared command bus, a memory system may reduce the quantity of pins between the processing circuitry and the memory devices, which may in turn reduce the overall size of the memory system (e.g., the footprint of the memory system), may reduce design complexity by allowing for increased design flexibility, or both, among other benefits.

By way of example, at 305, a first command may be issued. The memory system controller may issue the first command to a first memory device 130-c-1 via a command bus. In some examples, issuing the first command may include broadcasting the first command to the first memory device 130-c-1 and the second memory device 130-c-2. In such cases, the memory system controller may activate a first chip enable pin between the memory system controller and the first memory device 130-c-1 while broadcasting the first command, and may deactivate a second chip enable pin between the memory system controller and a second memory device 130-c-2 while broadcasting the first command.

At 310, a second command may be issued. The memory system controller may issue the second command to a second memory device 130-c-2 via the command bus. In some examples, issuing the second command may include broadcasting the second command to the first memory device 130-c-1 and the second memory device 130-c-2. In such cases, the memory system controller may deactivate the first chip enable pin between the memory system controller and the first memory device 130-c-1 while broadcasting the second command, and may activate the second chip enable pin between the memory system controller and the second memory device 130-c-2 while broadcasting the second command.

At 315, first data associated with the first command may be communicated. For example, if the first command includes a write command, the memory system controller may transmit data associated with the write command over a first data bus to the first memory device 130-c-1. Alternatively, if the first command includes a read command, the first memory device 130-c-1 may transmit data associated with the read command over the first data bus to the memory system controller.

At 320, second data associated with the second command may be communicated.

For example, if the second command includes a write command, the memory system controller may transmit data associated with the write command over a second data bus to the second memory device 130-c-2. Alternatively, if the second command includes a read command, the second memory device 130-c-2 may transmit data associated with the read command over the second data bus to the memory system controller. In some examples, the memory system controller may operate the command bus according to a first clock rate, and may operate the first data bus and the second data bus according to a second clock rate different than (e.g., slower than) the first clock rate.

In some cases, the memory system controller may include one or more interfaces. For example, the memory system controller may include an interface which includes first circuitry coupling the memory system controller with the first data bus and second circuitry coupling the memory system controller with the second data bus. Additionally, the interface may include a command router coupling the memory system controller with the command bus. Alternatively, the command router may be separate from (e.g., external to) the interface.

In some examples, the memory system may include one or more additional memory devices common to the command bus. For example, at 325, a third command may be issued. The memory system controller may issue the third command to a third memory device 130-c-3 via the command bus. In some examples, issuing the third command may include broadcasting the third command to the first memory device 130-c-1, the second memory device 130-c-2, and the third memory device 130-c-3. In such cases, the memory system controller may deactivate the first chip enable pin between the memory system controller and the first memory device 130-c-1 while broadcasting the third command, may deactivate the second chip enable pin between the memory system controller and the second memory device 130-c-2 while broadcasting the third command, and may activate a third chip enable pin between the memory system controller and the third memory device 130-c-3.

At 330, third data associated with the third command may be communicated. For example, if the third command includes a write command, the memory system controller may transmit data associated with the write command over a third data bus to the third memory device 130-c-3. Alternatively, if the third command includes a read command, the third memory device 130-c-3 may transmit data associated with the read command over the third data bus to the memory system controller.

Additionally, or alternatively, the memory system may include one or more memory devices coupled to the memory system controller via a second command bus separate from the command bus. For example, at 335, a fourth command may be issued. The memory system controller may issue the fourth command to a fourth memory device 130-c-4 via the second command bus. At 340, fourth data associated with the fourth command may be communicated. For example, if the fourth command includes a write command, the memory system controller may transmit data associated with the write command over a fourth data bus to the fourth memory device 130-c-4. Alternatively, if the fourth command includes a read command, the third memory device 130-c-3 may transmit data associated with the read command over the fourth data bus to the memory system controller.

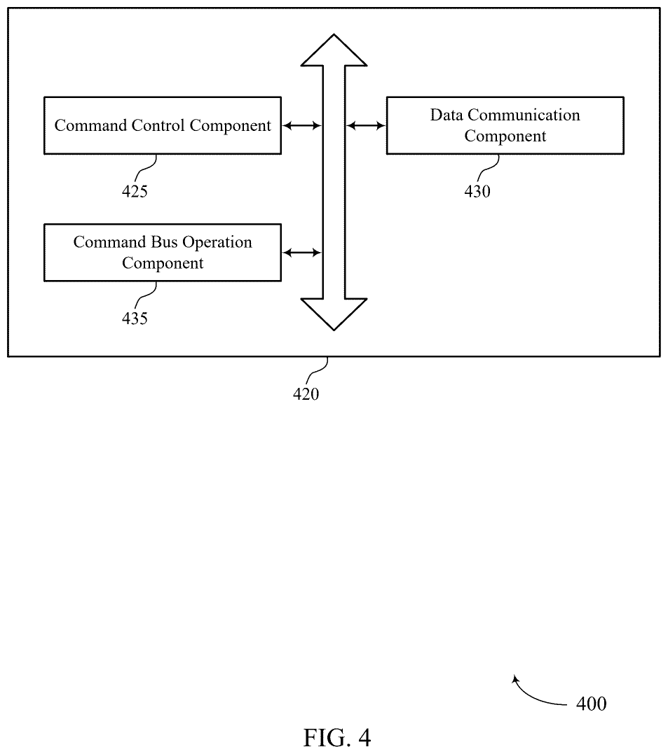

FIG. 4 shows a block diagram 400 of a memory system 420 that supports shared command bus architecture for memory systems in accordance with examples as disclosed herein. The memory system 420 may be an example of aspects of a memory system as described with reference to FIGS. 1 through 3. The memory system 420, or various components thereof, may be an example of means for performing various aspects of shared command bus architecture for memory systems as described herein. For example, the memory system 420 may include a command control component 425, a data communication component 430, a command bus operation component 435, or any combination thereof. Each of these components, or components of subcomponents thereof (e.g., one or more processors, one or more memories), may communicate, directly or indirectly, with one another (e.g., via one or more buses).

The command control component 425 may be configured as or otherwise support a means for issuing, by processing circuitry within a memory system including the processing circuitry and a plurality of memory devices coupled with the processing circuitry, one or more first commands associated with communication of first data to a first memory device of the plurality of memory devices via a first data bus and one or more second commands associated with communication of second data to a second memory device via a second data bus, where the one or more first commands and the one or more second commands are each issued via a command bus that is common to the first memory device and the second memory device. The data communication component 430 may be configured as or otherwise support a means for communicating, via the first data bus, the first data between the processing circuitry and the first memory device in accordance with the one or more first commands issued via the command bus. In some examples, the data communication component 430 may be configured as or otherwise support a means for communicating, via the second data bus, the second data between the processing circuitry and the second memory device in accordance with the one or more second commands issued via the command bus.

In some examples, to support issuing the one or more first commands and the one or more second commands, the command control component 425 may be configured as or otherwise support a means for issuing a first command to the first memory device via the command bus while a first chip enable pin between the processing circuitry and the first memory device is activated and a second chip enable pin between the processing circuitry and the second memory device is deactivated. In some examples, to support issuing the one or more first commands and the one or more second commands, the command control component 425 may be configured as or otherwise support a means for issuing a second command to the second memory device via the command bus while the first chip enable pin is deactivated and the second chip enable pin is activated.

In some examples, to support issuing the one or more first commands and the one or more second commands, the command control component 425 may be configured as or otherwise support a means for broadcasting the first command to the first memory device and the second memory device while the first chip enable pin is activated and the second chip enable pin is deactivated. In some examples, to support issuing the one or more first commands and the one or more second commands, the command control component 425 may be configured as or otherwise support a means for broadcasting the second command to the first memory device and the second memory device while the first chip enable pin is deactivated and the second chip enable pin is activated.

In some examples, the command bus operation component 435 may be configured as or otherwise support a means for operating the command bus in accordance with a first clock rate. In some examples, the command bus operation component 435 may be configured as or otherwise support a means for operating the first data bus and the second data bus in accordance with a second clock rate (e.g. concurrent with the command bus being operated in accordance with the first clock rate).

In some examples, the command control component 425 may be configured as or otherwise support a means for issuing, by the processing circuitry, one or more third commands associated with communication of third data to a third memory device of the plurality of memory devices via a third data bus and one or more fourth commands associated with communication of fourth data to a fourth memory device of the plurality of memory devices via a fourth data bus, where the one or more third commands and the one or more fourth commands are each issued via a second command bus that is common to the third memory device and the fourth memory device. In some examples, the data communication component 430 may be configured as or otherwise support a means for communicating, via the third data bus, the third data between the processing circuitry and the third memory device in accordance with the one or more third commands issued via the second command bus. In some examples, the data communication component 430 may be configured as or otherwise support a means for communicating, via the fourth data bus, the fourth data between the processing circuitry and the fourth memory device in accordance with the one or more fourth commands issued via the second command bus.

In some examples, the command control component 425 may be configured as or otherwise support a means for issuing, by the processing circuitry, one or more third commands associated with communication of third data to a third memory device of the plurality of memory devices via a third data bus and one or more fourth commands associated with communication of fourth data to a fourth memory device of the plurality of memory devices via a fourth data bus, where the one or more third commands and the one or more fourth commands are each issued via the command bus, and where the command bus is further common to the third memory device and the fourth memory device. In some examples, the data communication component 430 may be configured as or otherwise support a means for communicating, via the third data bus, the third data between the processing circuitry and the third memory device in accordance with the one or more third commands issued via the command bus. In some examples, the data communication component 430 may be configured as or otherwise support a means for communicating, via the fourth data bus, the fourth data between the processing circuitry and the fourth memory device in accordance with the one or more fourth commands issued via the command bus.

In some examples, the command bus includes one or more pins configured to communicate signaling indicating the one or more first commands and the one or more second commands, and the command bus further includes at least one additional pin configured to communicate a clock signal associated with the one or more first commands and the one or more second commands.

In some examples, the processing circuitry includes an interface, and the interface includes first circuitry coupling the processing circuitry with the first data bus, second circuitry coupling the processing circuitry with the second data bus, and a command router coupling the processing circuitry with the command bus.

In some examples, the processing circuitry includes a first interface that includes first circuitry coupling the processing circuitry with the first data bus, a second interface that is separate from the first interface and includes second circuitry coupling the processing circuitry with the second data bus, and a command router separate from the first interface and the second interface, the command router coupling the processing circuitry with the command bus.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

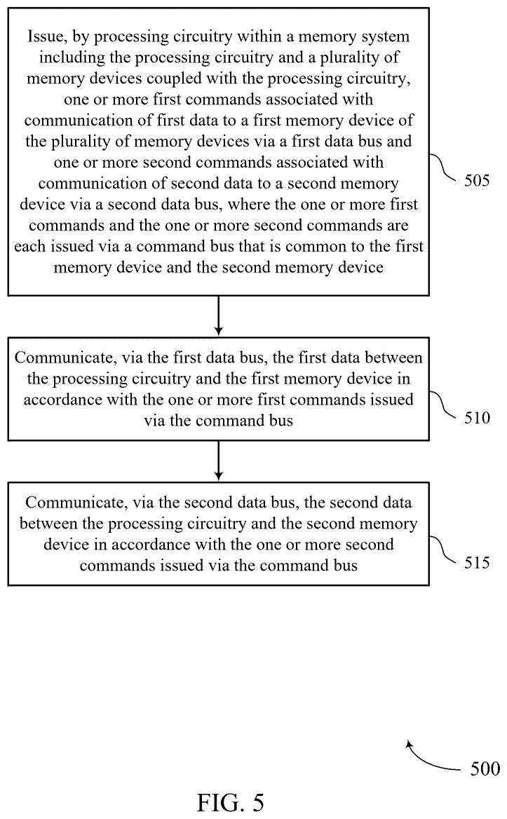

FIG. 5 shows a flowchart illustrating a method 500 that supports shared command bus architecture for memory systems in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include issuing, by processing circuitry within a memory system including the processing circuitry and a plurality of memory devices coupled with the processing circuitry, one or more first commands associated with communication of first data to a first memory device of the plurality of memory devices via a first data bus and one or more second commands associated with communication of second data to a second memory device via a second data bus, where the one or more first commands and the one or more second commands are each issued via a command bus that is common to the first memory device and the second memory device. In some examples, aspects of the operations of 505 may be performed by a command control component 425 as described with reference to FIG. 4.

At 510, the method may include communicating, via the first data bus, the first data between the processing circuitry and the first memory device in accordance with the one or more first commands issued via the command bus. In some examples, aspects of the operations of 510 may be performed by a data communication component 430 as described with reference to FIG. 4.

At 515, the method may include communicating, via the second data bus, the second data between the processing circuitry and the second memory device in accordance with the one or more second commands issued via the command bus. In some examples, aspects of the operations of 515 may be performed by a data communication component 430 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for issuing, by processing circuitry within a memory system including the processing circuitry and a plurality of memory devices coupled with the processing circuitry, one or more first commands associated with communication of first data to a first memory device of the plurality of memory devices via a first data bus and one or more second commands associated with communication of second data to a second memory device via a second data bus, where the one or more first commands and the one or more second commands are each issued via a command bus that is common to the first memory device and the second memory device; communicating, via the first data bus, the first data between the processing circuitry and the first memory device in accordance with the one or more first commands issued via the command bus; and communicating, via the second data bus, the second data between the processing circuitry and the second memory device in accordance with the one or more second commands issued via the command bus.

Aspect 2: The method, apparatus, or non-transitory computer-readable medium of aspect 1, where operations, features, circuitry, logic, means, or instructions, or any combination thereof for issuing the one or more first commands and the one or more second commands includes operations, features, circuitry, logic, means, or instructions, or any combination thereof for issuing a first command to the first memory device via the command bus while a first chip enable pin between the processing circuitry and the first memory device is activated and a second chip enable pin between the processing circuitry and the second memory device is deactivated and for issuing a second command to the second memory device via the command bus while the first chip enable pin is deactivated and the second chip enable pin is activated.

Aspect 3: The method, apparatus, or non-transitory computer-readable medium of aspect 2, where operations, features, circuitry, logic, means, or instructions, or any combination thereof for issuing the one or more first commands and the one or more second commands further includes operations, features, circuitry, logic, means, or instructions, or any combination thereof for broadcasting the first command to the first memory device and the second memory device while the first chip enable pin is activated and the second chip enable pin is deactivated and for broadcasting the second command to the first memory device and the second memory device while the first chip enable pin is deactivated and the second chip enable pin is activated.

Aspect 4: The method, apparatus, or non-transitory computer-readable medium of any of aspects 1 through 3, further including operations, features, circuitry, logic, means, or instructions, or any combination thereof for operating the command bus in accordance with a first clock rate and operating the first data bus and the second data bus in accordance with a second clock rate.

Aspect 5: The method, apparatus, or non-transitory computer-readable medium of any of aspects 1 through 4, where the command bus includes one or more pins configured to communicate signaling indicating the one or more first commands and the one or more second commands; and the command bus includes at least one additional pin configured to communicate a clock signal associated with the one or more first commands and the one or more second commands.

Aspect 6: The method, apparatus, or non-transitory computer-readable medium of any of aspects 1 through 5, where the processing circuitry includes an interface, the interface including first circuitry coupling the processing circuitry with the first data bus; second circuitry coupling the processing circuitry with the second data bus; and a command router coupling the processing circuitry with the command bus.

Aspect 7: The method, apparatus, or non-transitory computer-readable medium of any of aspects 1 through 6, where the processing circuitry includes a first interface including first circuitry coupling the processing circuitry with the first data bus; a second interface separate from the first interface, the second interface including second circuitry coupling the processing circuitry with the second data bus; and a command router separate from the first interface and the second interface, the command router coupling the processing circuitry with the command bus.

Aspect 8: The method, apparatus, or non-transitory computer-readable medium of any of aspects 1 through 7, further including operations, features, circuitry, logic, means, or instructions, or any combination thereof for issuing, by the processing circuitry, one or more third commands associated with communication of third data to a third memory device of the plurality of memory devices via a third data bus and one or more fourth commands associated with communication of fourth data to a fourth memory device of the plurality of memory devices via a fourth data bus, where the one or more third commands and the one or more fourth commands are each issued via a second command bus that is common to the third memory device and the fourth memory device; communicating, via the third data bus, the third data between the processing circuitry and the third memory device in accordance with the one or more third commands issued via the second command bus; and communicating, via the fourth data bus, the fourth data between the processing circuitry and the fourth memory device in accordance with the one or more fourth commands issued via the second command bus.

Aspect 9: The method, apparatus, or non-transitory computer-readable medium of any of aspects 1 through 8, further including operations, features, circuitry, logic, means, or instructions, or any combination thereof for issuing, by the processing circuitry, one or more third commands associated with communication of third data to a third memory device of the plurality of memory devices via a third data bus and one or more fourth commands associated with communication of fourth data to a fourth memory device of the plurality of memory devices via a fourth data bus, where the one or more third commands and the one or more fourth commands are each issued via the command bus, and where the command bus is further common to the third memory device and the fourth memory device; communicating, via the third data bus, the third data between the processing circuitry and the third memory device in accordance with the one or more third commands issued via the command bus; and communicating, via the fourth data bus, the fourth data between the processing circuitry and the fourth memory device in accordance with the one or more fourth commands issued via the command bus.

It should be noted that the described techniques include possible implementations, and that the operations and the steps may be rearranged or otherwise modified and that other implementations are possible. Further, portions from two or more of the methods may be combined.

An apparatus is described. The following provides an overview of aspects of the apparatus as described herein:

Aspect 10: A memory system, including: processing circuitry; a plurality of memory devices coupled with the processing circuitry, the plurality of memory devices including a first memory device and a second memory device; a first data bus configured to communicate first data between the processing circuitry and the first memory device; a second data bus, the second data bus configured to communicate second data between the processing circuitry and the second memory device; and a command bus common to the first memory device and the second memory device, the command bus including a plurality of pins each configured to communicate one or more first commands to the first memory device associated with data transfer via the first data bus and one or more second commands to the second memory device associated with data transfer via the second data bus.

Aspect 11: The memory system of aspect 10, further including: a first chip enable pin between the processing circuitry and the first memory device; and a second chip enable pin between the processing circuitry and the second memory device.

Aspect 12: The memory system of aspect 11, where the processing circuitry is configured to: issue a first command to the first memory device via the command bus while the first chip enable pin is activated and the second chip enable pin is deactivated; and issue a second command to the second memory device via the command bus while the first chip enable pin is deactivated and the second chip enable pin is activated.

Aspect 13: The memory system of aspect 12, where, to issue the first command and the second command, the processing circuitry is further configured to: broadcast the first command to the first memory device and the second memory device while the first chip enable pin is activated and the second chip enable pin is deactivated; and broadcast the second command to the first memory device and the second memory device while the first chip enable pin is activated and the second chip enable pin is deactivated.

Aspect 14: The memory system of any of aspects 10 through 13, where the processing circuitry includes an interface, the interface including: first circuitry coupling the processing circuitry with the first data bus; second circuitry coupling the processing circuitry with the second data bus; and a command router coupling the processing circuitry with the command bus.

Aspect 15: The memory system of any of aspects 10 through 14, where the processing circuitry includes: a first interface including first circuitry coupling the processing circuitry with the first data bus; a second interface separate from the first interface, the second interface including second circuitry coupling the processing circuitry with the second data bus; and a command router separate from the first interface and the second interface, the command router coupling the processing circuitry with the command bus.

Aspect 16: The memory system of any of aspects 10 through 15, further including: a third data bus configured to communicate third data between the processing circuitry and a third memory device of the plurality of memory devices; a fourth data bus configured to communicate fourth data between the processing circuitry and a fourth memory device of the plurality of memory devices; and a second command bus common to the third memory device and the fourth memory device, the second command bus including a plurality of second pins each configured to communicate one or more third commands to the third memory device associated with data transfer via the third data bus and one or more fourth commands to the fourth memory device associated with data transfer via the fourth data bus.

Aspect 17: The memory system of any of aspects 10 through 16, further including: a third data bus configured to communicate third data between the processing circuitry and a third memory device of the plurality of memory devices; and a fourth data bus configured to communicate fourth data between the processing circuitry and a fourth memory device of the plurality of memory devices, where the command bus is also common to the third memory device and the fourth memory device, and where each pin of plurality of pins within the command bus is further configured to communicate one or more third commands to the third memory device associated with data transfer via the third data bus and one or more fourth commands to the fourth memory device associated with data transfer via the fourth data bus.

Aspect 18: The memory system of any of aspects 10 through 17, where the command bus includes: one or more pins configured to communicate signaling indicating the one or more first commands and the one or more second commands; and at least one additional pin configured to communicate a clock signal associated with the one or more first commands and the one or more second commands.

Aspect 19: The memory system of any of aspects 10 through 18, where the command bus is operable to use a first clock rate while the first data bus and the second data bus use a second clock rate.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
processing circuitry;
a plurality of memory devices coupled with the processing circuitry, the plurality of memory devices comprising a first memory device and a second memory device;
a first data bus configured to communicate first data between the processing circuitry and the first memory device;
a second data bus, the second data bus configured to communicate second data between the processing circuitry and the second memory device; and
a command bus common to the first memory device and the second memory device, the command bus comprising a plurality of pins each configured to communicate one or more first commands to the first memory device associated with data transfer via the first data bus and one or more second commands to the second memory device associated with data transfer via the second data bus.

2. The memory system of claim 1, further comprising:
a first chip enable pin between the processing circuitry and the first memory device; and
a second chip enable pin between the processing circuitry and the second memory device.

3. The memory system of claim 2, wherein the processing circuitry is configured to:
issue a first command to the first memory device via the command bus while the first chip enable pin is activated and the second chip enable pin is deactivated; and
issue a second command to the second memory device via the command bus while the first chip enable pin is activated and the second chip enable pin is deactivated.

4. The memory system of claim 3, wherein, to issue the first command and the second command, the processing circuitry is further configured to:
broadcast the first command to the first memory device and the second memory device while the first chip enable pin is activated and the second chip enable pin is deactivated; and
broadcast the second command to the first memory device and the second memory device while the first chip enable pin is activated and the second chip enable pin is deactivated.

5. The memory system of claim 1, wherein the processing circuitry comprises an interface, the interface comprising:
first circuitry coupling the processing circuitry with the first data bus;
second circuitry coupling the processing circuitry with the second data bus; and
a command router coupling the processing circuitry with the command bus.

6. The memory system of claim 1, wherein the processing circuitry comprises:
a first interface comprising first circuitry coupling the processing circuitry with the first data bus;
a second interface separate from the first interface, the second interface comprising second circuitry coupling the processing circuitry with the second data bus; and
a command router separate from the first interface and the second interface, the command router coupling the processing circuitry with the command bus.

7. The memory system of claim 1, further comprising:
a third data bus configured to communicate third data between the processing circuitry and a third memory device of the plurality of memory devices;
a fourth data bus configured to communicate fourth data between the processing circuitry and a fourth memory device of the plurality of memory devices; and
a second command bus common to the third memory device and the fourth memory device, the second command bus comprising a plurality of second pins each configured to communicate one or more third commands to the third memory device associated with data transfer via the third data bus and one or more fourth commands to the fourth memory device associated with data transfer via the fourth data bus.

8. The memory system of claim 1, further comprising:
a third data bus configured to communicate third data between the processing circuitry and a third memory device of the plurality of memory devices; and
a fourth data bus configured to communicate fourth data between the processing circuitry and a fourth memory device of the plurality of memory devices, wherein the command bus is also common to the third memory device and the fourth memory device, and wherein each pin of plurality of pins within the command bus is further configured to communicate one or more third commands to the third memory device associated with data transfer via the third data bus and one or more fourth commands to the fourth memory device associated with data transfer via the fourth data bus.

9. The memory system of claim 1, wherein the command bus comprises:
one or more pins configured to communicate signaling indicating the one or more first commands and the one or more second commands; and
at least one additional pin configured to communicate a clock signal associated with the one or more first commands and the one or more second commands.

10. The memory system of claim 1, wherein the command bus is operable to use a first clock rate while the first data bus and the second data bus use a second clock rate.

11. A non-transitory computer-readable medium storing code, the code comprising instructions executable by processing circuitry to:
issue, by the processing circuitry within a memory system comprising a plurality of memory devices coupled with the processing circuitry, one or more first commands associated with communication of first data to a first memory device of the plurality of memory devices via a first data bus and one or more second commands associated with communication of second data to a second memory device via a second data bus, wherein the instructions are executable by the processing circuitry to issue each of the one or more first commands and the one or more second commands via a command bus that is common to the first memory device and the second memory device;
communicate, via the first data bus, the first data between the processing circuitry and the first memory device in accordance with the one or more first commands issued via the command bus; and
communicate, via the second data bus, the second data between the processing circuitry and the second memory device in accordance with the one or more second commands issued via the command bus.

12. The non-transitory computer-readable medium of claim 11, wherein, to issue the one or more first commands and the one or more second commands, the instructions are executable by the processing circuitry to:
issue a first command to the first memory device via the command bus while a first chip enable pin between the processing circuitry and the first memory device is activated and a second chip enable pin between the processing circuitry and the second memory device is deactivated; and
issue a second command to the second memory device via the command bus while the first chip enable pin is deactivated and the second chip enable pin is activated.

13. The non-transitory computer-readable medium of claim 12, wherein, to issue the one or more first commands and the one or more second commands, the instructions are further executable by the processing circuitry to:
broadcast the first command to the first memory device and the second memory device while the first chip enable pin is activated and the second chip enable pin is deactivated; and
broadcast the second command to the first memory device and the second memory device while the first chip enable pin is deactivated and the second chip enable pin is activated.

14. The non-transitory computer-readable medium of claim 11, wherein the instructions are further executable by the processing circuitry to:
operate the command bus in accordance with a first clock rate; and
operate the first data bus and the second data bus in accordance with a second clock rate.

15. The non-transitory computer-readable medium of claim 11, wherein the command bus comprises:
one or more pins configured to communicate signaling indicating the one or more first commands and the one or more second commands; and
at least one additional pin configured to communicate a clock signal associated with the one or more first commands and the one or more second commands.

16. The non-transitory computer-readable medium of claim 11, wherein the processing circuitry comprises an interface, the interface comprising:
first circuitry coupling the processing circuitry with the first data bus;
second circuitry coupling the processing circuitry with the second data bus; and
a command router coupling the processing circuitry with the command bus.

17. The non-transitory computer-readable medium of claim 11, wherein the processing circuitry comprises:
a first interface comprising first circuitry coupling the processing circuitry with the first data bus;
a second interface separate from the first interface, the second interface comprising second circuitry coupling the processing circuitry with the second data bus; and
a command router separate from the first interface and the second interface, the command router coupling the processing circuitry with the command bus.

18. The non-transitory computer-readable medium of claim 11, wherein the instructions are further executable by the processing circuitry to:
issue, by the processing circuitry, one or more third commands associated with communication of third data to a third memory device of the plurality of memory devices via a third data bus and one or more fourth commands associated with communication of fourth data to a fourth memory device of the plurality of memory devices via a fourth data bus, wherein the instructions are executable by the processing circuitry to issue each of the one or more third commands and the one or more fourth commands via a second command bus that is common to the third memory device and the fourth memory device;
communicate, via the third data bus, the third data between the processing circuitry and the third memory device in accordance with the one or more third commands issued via the second command bus; and
communicate, via the fourth data bus, the fourth data between the processing circuitry and the fourth memory device in accordance with the one or more fourth commands issued via the second command bus.

19. The non-transitory computer-readable medium of claim 11, wherein the instructions are further executable by the processing circuitry to:
issue, by the processing circuitry, one or more third commands associated with communication of third data to a third memory device of the plurality of memory devices via a third data bus and one or more fourth commands associated with communication of fourth data to a fourth memory device of the plurality of memory devices via a fourth data bus, wherein the instructions are executable by the processing circuitry to issue each of the one or more third commands and the one or more fourth commands via the command bus, and wherein the command bus is further common to the third memory device and the fourth memory device;
communicate, via the third data bus, the third data between the processing circuitry and the third memory device in accordance with the one or more third commands issued via the command bus; and
communicate, via the fourth data bus, the fourth data between the processing circuitry and the fourth memory device in accordance with the one or more fourth commands issued via the command bus.

20. A method, comprising:
issuing, by processing circuitry within a memory system comprising the processing circuitry and a plurality of memory devices coupled with the processing circuitry, one or more first commands associated with communication of first data to a first memory device of the plurality of memory devices via a first data bus and one or more second commands associated with communication of second data to a second memory device via a second data bus, wherein the one or more first commands and the one or more second commands are each issued via a command bus that is common to the first memory device and the second memory device;
communicating, via the first data bus, the first data between the processing circuitry and the first memory device in accordance with the one or more first commands issued via the command bus; and
communicating, via the second data bus, the second data between the processing circuitry and the second memory device in accordance with the one or more second commands issued via the command bus.

21. The method of claim 20, wherein issuing the one or more first commands and the one or more second commands comprises:
issuing a first command to the first memory device via the command bus while a first chip enable pin between the processing circuitry and the first memory device is activated and a second chip enable pin between the processing circuitry and the second memory device is deactivated; and
issuing a second command to the second memory device via the command bus while the first chip enable pin is deactivated and the second chip enable pin is activated.

22. The method of claim 21, wherein issuing the one or more first commands and the one or more second commands further comprises:
broadcasting the first command to the first memory device and the second memory device while the first chip enable pin is activated and the second chip enable pin is deactivated; and
broadcasting the second command to the first memory device and the second memory device while the first chip enable pin is deactivated and the second chip enable pin is activated.

23. The method of claim 20, further comprising:
operating the command bus in accordance with a first clock rate; and
operating the first data bus and the second data bus in accordance with a second clock rate.

24. The method of claim 20, wherein the command bus comprises:
one or more pins configured to communicate signaling indicating the one or more first commands and the one or more second commands; and
at least one additional pin configured to communicate a clock signal associated with the one or more first commands and the one or more second commands.

25. The method of claim 20, wherein the processing circuitry comprises an interface, the interface comprising:
first circuitry coupling the processing circuitry with the first data bus;
second circuitry coupling the processing circuitry with the second data bus; and
a command router coupling the processing circuitry with the command bus.
